(19) United States
(12) Patent Application Publication
(10) Pub. No.: US 2020/0081612 A1
(43) Pub. Date: Mar. 12, 2020

(54) DISPLAY CONTROL DEVICE

(71) Applicant: AISIN SEIKI KABUSHIKI KAISHA, Kariya-shi (JP)

(72) Inventors: Kinji YAMAMOTO, Anjo-shi (JP); Kazuya WATANABE, Anjo-shi (JP); Jun ADACHI, Okazaki-shi (JP)

(73) Assignee: AISIN SEIKI KABUSHIKI KAISHA, Kariya-shi (JP)

(21) Appl. No.: 16/561,240

(22) Filed: Sep. 5, 2019

(30) Foreign Application Priority Data
Sep. 6, 2018 (JP) 2018-167351

(51) Int. Cl. G06F 3/0484; H04N 5/265; H04N 5/445; G06F 3/0482; G06F 3/0481; B60R 1/00

(52) U.S. Cl. CPC G06F 3/04847; H04N 5/265; H04N 5/445; H04N 5/247; G06F 3/04817; G06F 3/04845; B60R 1/00; G06F 3/0482

(57) ABSTRACT

A display control device includes: an image acquisition unit configured to acquire captured image data from an imaging unit configured to capture an image of a peripheral area of a vehicle; a display control unit configured to cause composite image data generated based on the captured image data to be displayed on a composite image data screen; and an operation receiving unit configured to receive an operation from a user. The display control unit causes the composite image data screen to transit to a setting screen on which a display mode of vehicle information on the composite image data screen is selectable when the operation receiving unit receives selection of display information on the composite image data screen, and causes a selected display mode to be displayed on the composite image data screen when the operation receiving unit receives selection of the display mode on the setting screen.

### CROSS REFERENCE TO RELATED APPLICATIONS

This application is based on and claims priority under 35 U.S.C. § 119 to Japanese Patent Application 2018-167351, filed on Sep. 6, 2018, the entire contents of which are incorporated herein by reference.

### TECHNICAL FIELD

This disclosure relates to a display control device.

### BACKGROUND DISCUSSION

In the related art, a system has been proposed in which a vehicle icon indicating the current position of a user is superimposed and displayed on map information displayed on a display (see, e.g., JP 2017-072531A (Reference 1)).

Meanwhile, there has been proposed a vehicle periphery monitoring device which causes a driver to recognize the situation around a vehicle by capturing an image of the periphery of the vehicle using a plurality of imaging units provided around the vehicle and combining a plurality of captured image data to generate and display a three-dimensional composite image on an in-vehicle display device.

The above-described related art has room for further improvement in terms of improving the controllability of display.

### SUMMARY

A display control device according to an aspect of this disclosure includes, as an example, an image acquisition unit configured to acquire captured image data from an imaging unit configured to capture an image of a peripheral area of a vehicle, a display control unit configured to cause composite image data generated based on the captured image data to be displayed on a composite image data screen, and an operation receiving unit configured to receive an operation from a user, wherein the display control unit causes the composite image data screen to transit to a setting screen on which a display mode of vehicle information on the composite image data screen is selectable when the operation receiving unit receives selection of display information displayed on the composite image data screen, and causes a selected display mode to be displayed on the composite image data screen as the display mode of the vehicle information when the operation receiving unit receives selection of the display mode on the setting screen.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view illustrating an example of a state where a portion of a vehicle cabin of a vehicle equipped with a display control device according to an embodiment is seen through the vehicle;

FIG. 2 is a plan view illustrating an example of the vehicle equipped with the display control device according to the embodiment;

FIG. 3 is a block diagram illustrating an example of a configuration of an ECU and a peripheral configuration thereof according to the embodiment;

FIG. 4 is a diagram exemplifying a software configuration realized by the ECU according to the embodiment;

FIG. 5 is a flow diagram illustrating an example of a procedure of controlling a change of the vehicle body color of a vehicle icon by a display control unit according to an embodiment;

FIG. 6 is a flow diagram illustrating an example of a procedure of selecting a vehicle body color on a vehicle body color selection screen displayed by the display control unit according to the embodiment;

FIG. 7 is a flow diagram illustrating an example of a procedure of selecting a vehicle body color on a vehicle body color selection screen displayed by the display control unit according to a first modification of the embodiment;

FIG. 8 is a flow diagrams illustrating an example of a procedure of selecting a vehicle body color on a vehicle body color selection screen displayed by the display control unit according to a second modification of the embodiment;

FIG. 9 is a flow diagram illustrating an example of a procedure of selecting parts of a vehicle icon on a part selection screen displayed by the display control unit according to a third modification of the embodiment; and

FIG. 10 is a flow diagrams illustrating an example of a procedure of controlling a change of the vehicle body color of a vehicle icon by the display control unit according to a fourth modification of the embodiment.

### DETAILED DESCRIPTION

Hereinafter, exemplary embodiments disclosed here will be disclosed. A configuration of the embodiments described below and actions, results, and effects caused by the configuration are given by way of example. The disclosure may be realized by a configuration other than the configuration disclosed in the following embodiments, and at least one of various effects based on a basic configuration and derivative effects may be obtained.

### (Configuration of Vehicle)

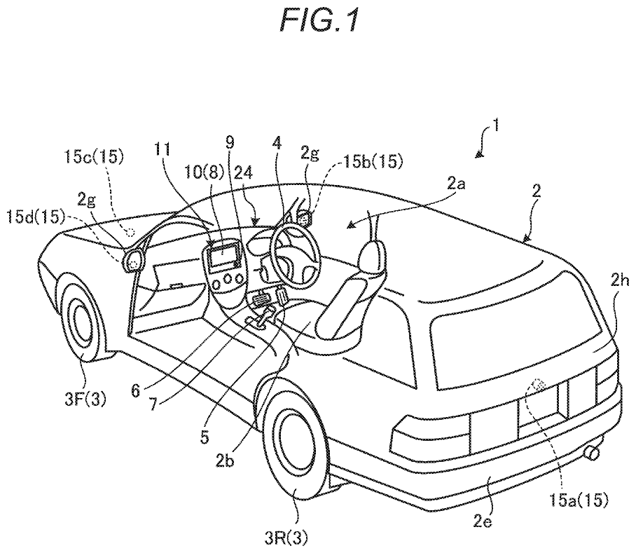

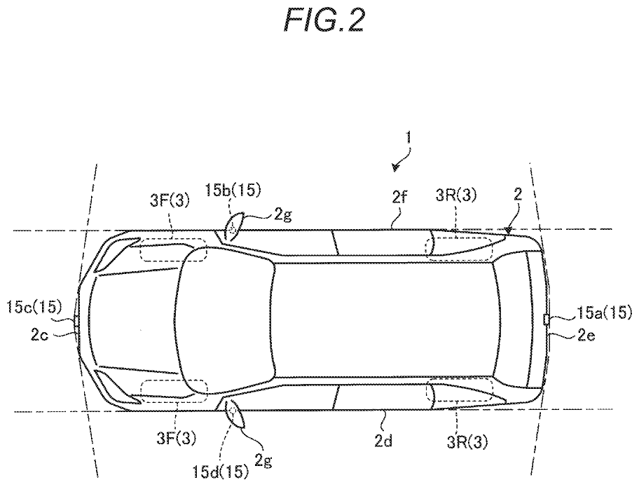

FIG. 1 is a perspective view illustrating an example of a state where a portion of a vehicle cabin 2a of a vehicle 1 equipped with a display control device according to an embodiment is seen through the vehicle. FIG. 2 is a plan view illustrating an example of the vehicle 1 equipped with the display control device according to the embodiment.

The vehicle 1 according to the embodiment may be, for example, an automobile having an internal combustion engine as a drive source, i.e., internal combustion engine automobile, an automobile having an electric motor (not illustrated) as a drive source, i.e., an electric automobile or a fuel cell automobile, or a hybrid automobile having both the internal combustion engine and the electric motor as a drive source, or may be an automobile having any other drive source. Further, the vehicle 1 may be equipped with any of various speed-change devices, and may be equipped with various devices, for example, systems or components which are required for driving the internal combustion engine or the electric motor. Further, the type, the number, and the layout of devices related to the driving of wheels 3 in the vehicle 1 may be set in various ways.

As illustrated in FIG. 1, a vehicle body 2 configures the vehicle cabin 2a on which a passenger (not illustrated) rides. In the vehicle cabin 2a, a steering unit 4, an acceleration operation unit 5, a braking operation unit 6, a speed-change operation unit 7, and the like are provided in a state of facing a seat 2b of a driver as a passenger. The steering unit 4 is, for example, a steering wheel that protrudes from a dashboard 24. The acceleration operation unit 5 is, for example, an accelerator pedal that is located under the driver's feet. The braking operation unit 6 is, for example, a brake pedal that is located under the driver's feet. The speed-change operation unit 7 is, for example, a shift lever that protrudes from a center console. In addition, the steering unit 4, the acceleration operation unit 5, the braking operation unit 6, the speed-change operation unit 7, and the like are not limited thereto.

Further, in the vehicle cabin 2a, a display device 8 and a voice output device 9 are provided. The voice output device 9 is, for example, a speaker. The display device 8 is, for example, a liquid crystal display (LCD) or an organic electroluminescent display (OELD). The display device 8 is covered with a transparent operation input unit 10 such as a touch panel and the like. A passenger may visually recognize an image displayed on a display screen of the display device 8 through the operation input unit 10. Further, the passenger may execute an operation input by touching, pushing, or moving a position of the operation input unit 10 corresponding to the image displayed on the display screen of the display device 8 with the finger. For example, the display device 8, the voice output device 9, and the operation input unit 10 are provided, for example, in a monitor device 11 located at the center of the dashboard 24 in the vehicle width direction, i.e., in the transverse direction. The monitor device 11 may have an operation input unit (not illustrated) such as a switch, a dial, a joystick, or a push button. Further, a voice output device (not illustrated) may be provided at another position in the vehicle cabin 2a other than the monitor device 11. Furthermore, voice may be output from both the voice output device 9 of the monitor device 11 and the other voice output device. In addition, the monitor device 11 may also be used as, for example, a navigation system or an audio system.

As illustrated in FIGS. 1 and 2, the vehicle 1 is, for example, a four-wheel vehicle, and includes two left and right front wheels 3F and two left and right rear wheels 3R. All of these four wheels 3 may be configured to be steerable.

Further, the vehicle body 2 is, for example, provided with four imaging units 15a to 15d as a plurality of imaging units 15. The imaging unit 15 is, for example, a digital camera having an imaging element such as a charge coupled device (CCD) or a CMOS image sensor (CIS) incorporated therein. The imaging unit 15 may output captured image data at a predetermined frame rate. The captured image data may be moving image data. Each imaging unit 15 has a wide-angle lens or a fish-eye lens, and may capture an image within a range, for example, from 140° to 220° in the horizontal direction. Further, the optical axis of the imaging unit 15 may be set obliquely downward. Thus, the imaging unit 15 sequentially captures an image of the peripheral environment outside the vehicle 1 including the road surface on which the vehicle 1 is movable or an object, and outputs the captured image as captured image data. Here, the object is a rock, a tree, a person, a bicycle, or another vehicle, for example, which may become an obstacle, for example, at the time of driving of the vehicle 1.

The imaging unit 15a is located, for example, on a right end 2e of the vehicle body 2 and is provided on a wall portion below a rear window of a rear hatch door 2h. The imaging unit 15b is located, for example, on a right end 2f of the vehicle body 2 and is provided on a right door mirror 2g. The imaging unit 15c is located, for example, on the front side of the vehicle body 2, i.e., on a front end 2c in the longitudinal direction of the vehicle and is provided on a front bumper or a front grill. The imaging unit 15d is located, for example, on a left end 2d of the vehicle body 2 and is provided on a left door mirror 2g.

### (Hardware Configuration of ECU)

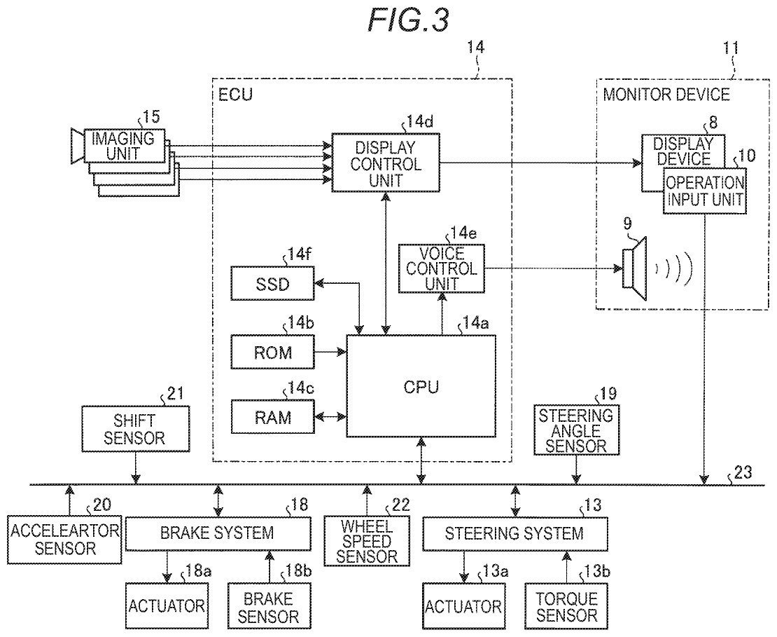

Next, an electronic control unit (ECU) 14 of the embodiment and a peripheral configuration of the ECU 14 will be described with reference to FIG. 3. FIG. 3 is a block diagram illustrating a configuration of the ECU 14 and a peripheral configuration thereof according to the first embodiment.

As illustrated in FIG. 3, in addition to the ECU 14 as a display control device, the monitor device 11, a steering system 13, a brake system 18, a steering angle sensor 19, an accelerator sensor 20, a shift sensor 21, a wheel speed sensor 22, and the like are electrically connected via an in-vehicle network 23 as an electric communication line. The in-vehicle network 23 is configured with, for example, a controller area network (CAN).

The ECU 14 may control the steering system 13, the brake system 18, and the like by transmitting a control signal through the in-vehicle network 23. Further, the ECU 14 may receive, for example, detection results of a torque sensor 13b, a brake sensor 18b, the steering angle sensor 19, the accelerator sensor 20, the shift sensor 21, and the wheel speed sensor 22 or an operation signal of the operation input unit 10 through the in-vehicle network 23.

Further, the ECU 14 may execute an arithmetic processing or an image processing based on image data obtained by the plurality of imaging units 15 to generate an image with a wider viewing angle or to generate a virtual bird's-eye view image of the vehicle 1 as viewed from above. In addition, the bird's-eye view image may also be referred to as a planar image.

The ECU 14 includes, for example, a central processing unit (CPU) 14a, a read only memory (ROM) 14b, a random access memory (RAM) 14c, a display control unit 14d, a voice control unit 14e, and a solid state drive (SSD) 14f.

The CPU 14a may execute, for example, various arithmetic processings and various controls such as an image processing related to an image displayed on the display device 8, determination of a target position of the vehicle 1, calculation of a movement route of the vehicle 1, determination of the presence or absence of interference with an object, automatic control of the vehicle 1, and cancellation of automatic control. The CPU 14a may read a program which is installed and stored in a non-volatile storage device such as the ROM 14b, and may execute an arithmetic processing according to the program.

The RAM 14c temporarily stores various data used in calculation in the CPU 14a.

The display control unit 14d mainly executes an image processing using image data obtained by the imaging unit 15 or combination of image data displayed by the display device 8 among the arithmetic processings in the ECU 14.

The voice control unit 14e mainly executes a processing of voice data output from the voice output device 9 among the arithmetic processings in the ECU 14.

The SSD 14f is a rewritable non-volatile storage unit and may store data even when a power supply of the ECU 14 is turned off.

In addition, the CPU 14a, the ROM 14b, and the RAM 14c may be integrated in the same package. Further, the ECU 14 may be configured to use another logical operation processor such as a digital signal processor (DSP) or a logic circuit instead of the CPU 14a. Further, a hard disk drive (HDD) may be provided instead of the SSD 14f, and the SSD 14f or the HDD may be provided separately from the ECU 14.

The steering system 13 includes an actuator 13a and a torque sensor 13b and steers at least two wheels 3. That is, the steering system 13 is electrically controlled by the ECU 14 and the like to operate the actuator 13a. The steering system 13 is, for example, an electric power steering system or a steer-by-wire (SBW) system. The steering system 13 adds a torque, i.e., assistance torque to the steering unit 4 by the actuator 13a to supplement a steering force, or steers the wheel 3 by the actuator 13a. In this case, the actuator 13a may steer one wheel 3, or may steer a plurality of wheels 3. Further, the torque sensor 13b detects, for example, a torque that the driver gives to the steering unit 4.

The brake system 18 is, for example, an anti-lock brake system (ABS) that prevents locking of a brake, an electronic stability control (ESC) that prevents side slipping of the vehicle 1 during cornering, an electric brake system that increase a brake force to execute brake assistance, or a brake-by-wire (BBW). The brake system 18 applies a braking force to the wheel 3 and thus to the vehicle 1 via an actuator 18a. Further, the brake system 18 may execute various controls by detecting the locking of the brake, the idle rotation of the wheel 3, and the sign of side slipping from a difference in the rotation of the left and right wheels 3. The brake sensor 18b is, for example, a sensor that detects the position of a movable element of the braking operation unit 6. The brake sensor 18b may detect the position of a brake pedal as the movable element. The brake sensor 18b includes a displacement sensor.

The steering angle sensor 19 is, for example, a sensor that detects the steering amount of the steering unit 4 such as a steering wheel and the like. The steering angle sensor 19 is configured using a Hall element and the like. The ECU 14 acquires the steering amount of the steering unit 4 by the driver or the steering amount of each wheel 3 at the time of automatic steering from the steering angle sensor 19 to execute various controls. In addition, the steering angle sensor 19 detects the rotation angle of a rotating element included in the steering unit 4. The steering angle sensor 19 is an example of an angle sensor.

The accelerator sensor 20 is, for example, a sensor that detects the position of a movable element of the acceleration operation unit 5. The accelerator sensor 20 may detect the position of an accelerator pedal as the movable element. The accelerator sensor 20 includes a displacement sensor.

The shift Csensor 21 is, for example, a sensor that detects the position of a movable element of the speed-change operation unit 7. The shift sensor 21 may detect the position of a lever, an arm, or a button as the movable element. The shift sensor 21 may include a displacement sensor, or may be configured as a switch.

The wheel speed sensor 22 is a sensor that detects the amount of rotation or the number of revolutions per unit time of the wheel 3. The wheel speed sensor 22 outputs a wheel speed pulse number indicating the detected number of revolutions as a sensor value. The wheel speed sensor 22 may be configured using, for example, a Hall element. The ECU 14 calculates the amount of movement of the vehicle 1 based on the sensor value acquired from the wheel speed sensor 22 to execute various controls. In addition, the wheel speed sensor 22 may be provided in the brake system 18 in some cases. In that case, the ECU 14 acquires the detection result of the wheel speed sensor 22 via the brake system 18.

In addition, the configuration, arrangement, and electrical connection form of various sensors or actuators described above are merely illustrative, and may be set and changed in various ways.

### (Software Configuration of ECU)

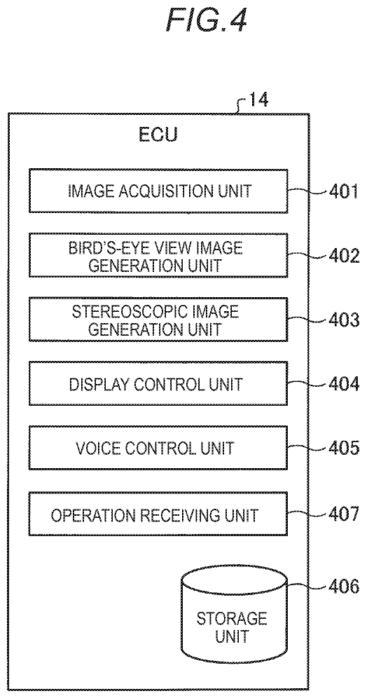

Next, a software configuration of the ECU 14 of the embodiment will be described with reference to FIG. 4. FIG. 4 is a diagram exemplifying a software configuration realized by the ECU 14 according to the embodiment.

As illustrated in FIG. 4, the ECU 14 includes an image acquisition unit 401, a bird's-eye view image generation unit 402, a stereoscopic image generation unit 403, a display control unit 404, a voice control unit 405, an operation receiving unit 407, and a storage unit 406. The CPU 14a functions as the image acquisition unit 401, the bird's-eye view image generation unit 402, the stereoscopic image generation unit 403, the display control unit 404, the voice control unit 405, or the operation receiving unit 407 by executing a processing according to a program. Further, the RAM 14c or the ROM 14b functions as the storage unit 406. In addition, at least some of the functions of the respective units may be realized by hardware. For example, the display control unit 404 may be realized by the display control unit 14d described above. Further, the voice control unit 405 may be realized by the voice control unit 14e described above. Further, the operation receiving unit 407 may be realized by the above-described operation input unit 10.

The image acquisition unit 401 acquires a plurality of captured image data from the plurality of imaging units 15 which capture an image of a peripheral area of the vehicle 1.

The bird's-eye view image generation unit 402 converts the captured image data acquired by the image acquisition unit 401 to generate bird's-eye view image data as composite image data based on a virtual viewpoint. As the virtual viewpoint, for example, it is conceivable to set a position that is upwardly spaced apart from the vehicle 1 by a predetermined distance. The bird's-eye view image data is image data generated by combining the captured image data acquired by the image acquisition unit 401, and is image data on which an image processing has been performed by the bird's-eye view image generation unit 402 so as to become display image data based on the virtual viewpoint. The bird's-eye view image data is image data indicating the periphery of the vehicle 1 from the bird's-eye viewpoint on the basis of a centrally disposed vehicle icon indicating the vehicle 1.

The stereoscopic image generation unit 403 generates virtual projection image data by projecting the captured image data acquired by the image acquisition unit 401 onto a virtual projection plane (three-dimensional shape model) surrounding the periphery of the vehicle 1 which is determined on the basis of the position where the vehicle 1 exists. Further, the stereoscopic image generation unit 403 disposes a vehicle shape model corresponding to the vehicle 1 stored in the storage unit 406 in a three-dimensional virtual space including the virtual projection plane. Thus, the stereoscopic image generation unit 403 generates stereoscopic image data as composite image data.

The display control unit 404 displays the captured image data acquired by the imaging unit 15 on the display device 8. Further, the display control unit 404 displays the bird's-eye view image data generated by the bird's-eye view image generation unit 402 on the display device 8. Further, the display control unit 404 displays the stereoscopic image data generated by the stereoscopic image generation unit 403 on the display device 8. Further, the display control unit 404 controls display content according to various user operations on the screen on which the captured image data, the bird's-eye view image data, the stereoscopic image data, and the like are displayed. Various controls by the display control unit 404 will be described later.

The voice control unit 405 combines an operation voice, various notification voices, and the like in the display device 8 and outputs the result to the voice output device 9.

The operation receiving unit 407 receives an operation by a user. For example, the operation receiving unit 407 may receive an operation input from the transparent operation input unit 10 provided on the display device 8, or may receive an operation from a switch or a dial. Furthermore, the operation receiving unit 407 may receive an operation from a touch pad provided as one corresponding to the display device 8.

The storage unit 406 stores data used in an arithmetic processing of each unit or data regarding the result of the arithmetic processing. Further, the storage unit 406 also stores various icons displayed by the display control unit 404, a vehicle shape model, voice data, and the like.

### (Vehicle Body Color Change Control by Display Control Unit)

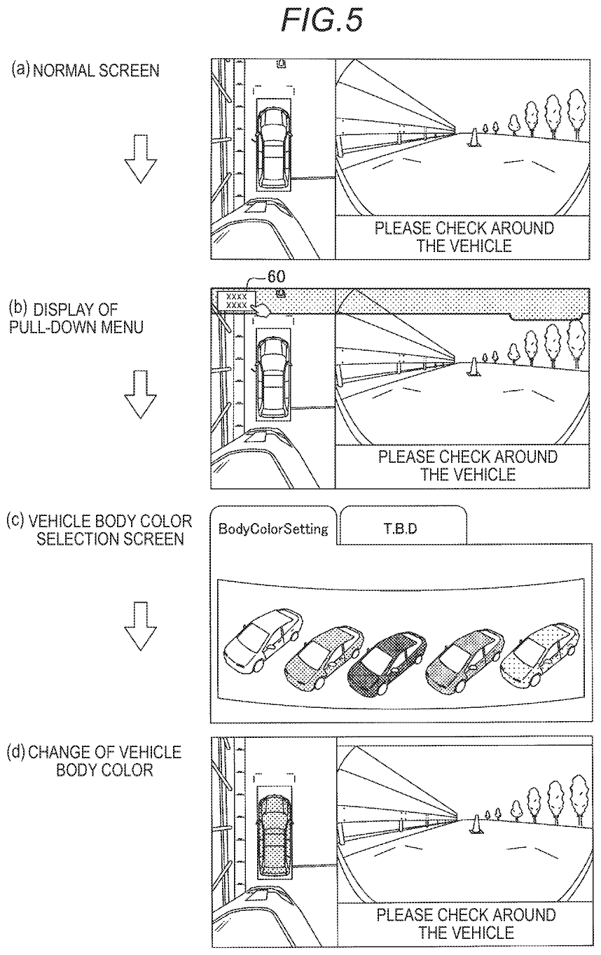

Next, control of changing a vehicle body color as a display mode of a vehicle icon as vehicle information by the display control unit 404 will be described with reference to FIG. 5. FIG. 5 is a flow diagram illustrating an example of a procedure of controlling a change of the vehicle body color of a vehicle icon by the display control unit 404 according to an embodiment. In FIG. 5, it is assumed that the screen as an initial screen (normal screen) of the display device 8 is divided into two left and right sides. Bird's-eye view image data generated by the bird's-eye view image generation unit 402 is displayed on the left side. On the right side, for example, captured image data indicating the front of the vehicle 1 captured by the imaging unit 15c on the front side of the vehicle 1 is displayed. Further, the screen on which the bird's-eye view image data is displayed may be called a bird's-eye view image data screen or a composite image data screen.

As illustrated in FIG. 5, the display control unit 404 performs control to enable a change of the vehicle body color of a vehicle icon displayed in the bird's-eye view image data on the display device 8 by a predetermined user operation. Moreover, when receiving the predetermined operation, the display control unit 404 performs not only a change of the vehicle body color of the vehicle icon displayed in the bird's-eye view image data but also a change of the vehicle body color of a vehicle shape model included in the above-described stereoscopic image data.

That is, as illustrated in (a) of FIG. 5, for example, when the user touches a predetermined position such as the upper right side of the screen in a state where the bird's-eye view image data is displayed on the display device 8, the operation receiving unit 407 receives designation by such user operation, and as illustrated in (b) of FIG. 5, the display control unit 404 displays a pull-down menu 60 on the screen.

When the user designates vehicle body color selection according to the pull-down menu 60, the operation receiving unit 407 receives such user designation, and as illustrated in (c) of FIG. 5, the display control unit 404 performs transition of the display screen to a vehicle body color selection screen. The vehicle body color selection screen is a setting screen on which the vehicle body color of the vehicle icon on the bird's-eye view image data screen is selectable. The vehicle body color selection screen and the selectable vehicle body color are stored, for example, in the storage unit 406. When the user selects a predetermined vehicle body color on the vehicle body color selection screen, the operation receiving unit 407 receives such user selection, and as illustrated in (d) of FIG. 5, the display control unit 404 returns the display to the bird's-eye view image data screen before transition. At this time, the display control unit 404 causes the vehicle icon in the bird's-eye view image data to be displayed in the vehicle body color which is selected by the user and is received by the operation receiving unit 407.

In the present embodiment, vehicle information which is a color change target is not limited to the vehicle icon indicating the shape of the vehicle and may be vehicle information displayed on the display device 8. For example, the vehicle information also includes the vehicle shape model corresponding to the vehicle 1 disposed in the stereoscopic image data.

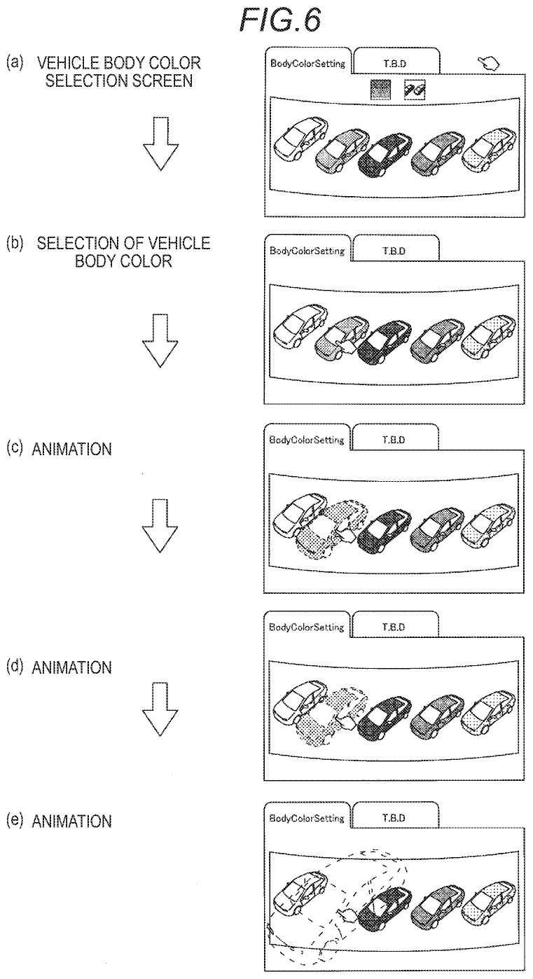

Here, the selection of a vehicle body color on the vehicle body color selection screen will be described in more detail with reference to FIG. 6. FIG. 6 is a flow diagram illustrating an example of a procedure of selecting a vehicle body color on a vehicle body color selection screen displayed by the display control unit 404 according to the embodiment.

As illustrated in (a) of FIG. 6, a plurality of vehicle icons having selectable different vehicle body colors are displayed on the vehicle body color selection screen. The user may select a vehicle body color from among a greater number of options by scrolling the vehicle body color selection screen to the left and the right. When the user touches a vehicle icon having an arbitrary vehicle body color, the operation receiving unit 407 receives designation by such user operation and as illustrated in (b) of FIG. 6, the display control unit 404 displays a finger mark indicating that a vehicle body color of a vehicle icon is selected on the vehicle icon which is touched by the user and is received by the operation receiving unit 407.

Next, as illustrated in (c) to (e) of FIG. 6, the display control unit 404 displays an animation in which the vehicle icon having the selected vehicle body color is gradually enlarged and is seen in a perspective state. The user may cancel the selection by touching the screen again during the procedure of (c) to (e) of FIG. 6, and may return to the original vehicle body color selection screen so as to reselect a vehicle body color. The operation receiving unit 407 receives such user selection cancellation and reselection of the vehicle body color.

When the transparency of the vehicle icon increases and the vehicle icon disappears completely, the display control unit 404 returns the display to the bird's-eye view image data screen before transition, and displays the vehicle icon in the selected vehicle body color.

### Comparative Example

For example, in the configuration of Reference 1 described above, an input of information on a display mode of an icon is received, and the icon is displayed in a display mode depending on the received display mode specifying information at a position corresponding to the current position of an own vehicle in map information. However, Reference 1 does not disclose a change of the display mode of the icon on a composite image data screen. Further, it is not possible to know whether or not an icon is correctly selected during a time period after a driver selects a preset icon from an icon list until a navigation screen is displayed.

According to the ECU 14 of the embodiment, the user may set the vehicle body color of the vehicle icon on the composite image data screen such as the bird's-eye view image data screen, and may reflect the user's favorite color on the vehicle body color. Therefore, it is also possible to meet a user need, for example, when the user wants to set a color different from an actual vehicle body color. Further, it is possible to improve the visibility of the vehicle icon on the display device 8, for example, by selecting a vehicle body color according to the display brightness of the bird's-eye view image data. At this time, it is preferable to set a low brightness vehicle body color on a high brightness display and a high brightness vehicle body color on a low brightness display.

According to the ECU 14 of the embodiment, since the vehicle icon is enlarged by the display of an animation, it is obvious at a glance which vehicle body color is selected. Further, it is also possible to redo selection while the animation is displayed. Further, when the display is switched from the animation to the bird's-eye view image data, since the arbitrary color designated by the user is superimposed on the vehicle icon, it looks as if the selected vehicle icon has moved from the vehicle body color selection screen. This makes it possible not only to obtain display consistency but also to improve amusement.

Hereinafter, various modifications of the embodiment will be described. In the following description, the same reference numerals will be attached to components corresponding to embodiments of various modifications with reference to FIGS. 1 to 4.

### First Modification

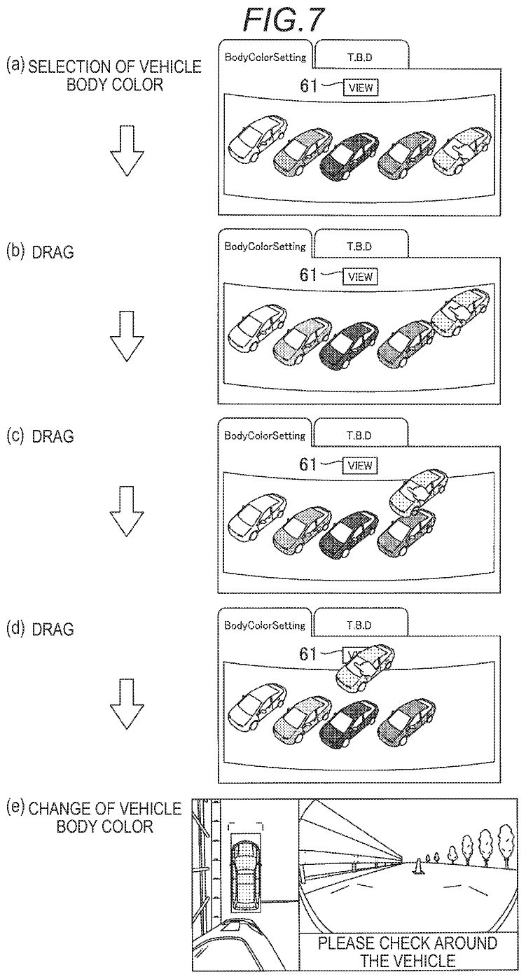

Another procedure of changing a vehicle body color will be described with reference to FIG. 7. FIG. 7 is a flow diagram illustrating an example of a procedure of selecting a vehicle body color on a vehicle body color selection screen displayed by the display control unit 404 according to a first modification of the embodiment. The example of the first modification differs from the above-described embodiment in that the vehicle body color is changed by dragging a vehicle icon.

As illustrated in (a) of FIG. 7, when the user touches a vehicle icon having an arbitrary vehicle body color on the vehicle body color selection screen, the operation receiving unit 407 receives designation by such user operation, and the display control unit 404 displays a finger mark indicating that the vehicle body color of the vehicle icon is selected on the vehicle icon which is touched by the user and is received by the operation receiving unit 407. As illustrated in (b) and (c) of FIG. 7, the user drags the selected vehicle icon while touching it. Then, as illustrated in (d) of FIG. 7, such an operation is received by the operation receiving unit 407, for example, by superimposing the dragged vehicle icon on a view icon 61 on the vehicle body color selection screen, and as illustrated in (e) of FIG. 7, the selected vehicle body color may be reflected on the vehicle icon in the bird's-eye view image data.

Alternatively, as another modification using no animation, even if the user touches a vehicle icon having an arbitrary vehicle body color on the vehicle body color selection screen, the operation receiving unit 407 may receive designation by such user operation, and the display control unit 404 may reflect the selected vehicle body color on the vehicle icon in the bird's-eye view image data.

As described above, for example, the procedure of selecting and changing a vehicle body color by selecting a predetermined vehicle icon from a plurality of vehicle icons having different vehicle body colors may be referred to as a list mode. A change of the vehicle body color may be performed by a color palette mode using a color palette to be described below, in addition to the list mode.

### Second Modification

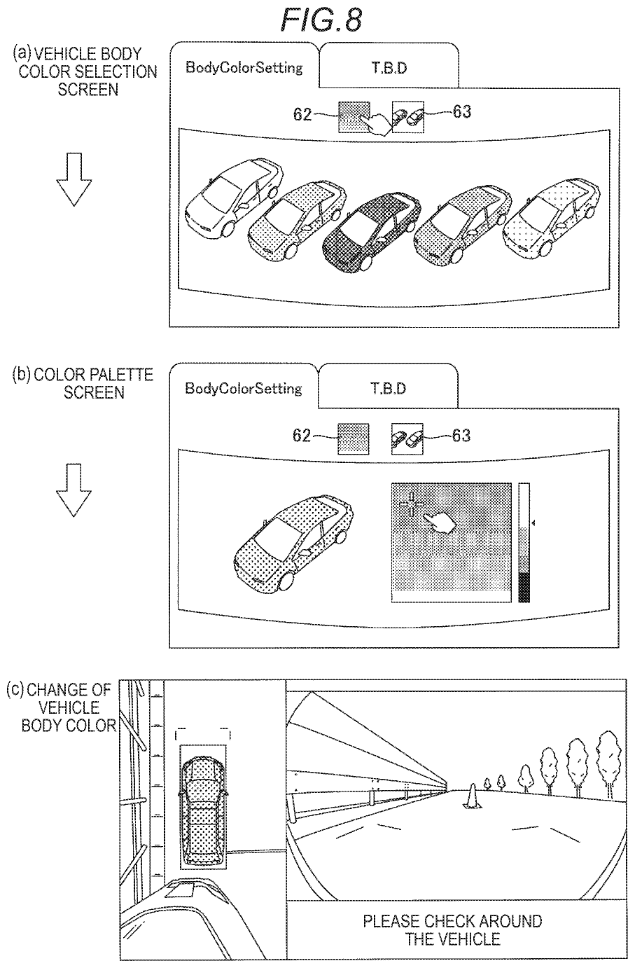

A procedure of changing a vehicle body color in the color palette mode will be described with reference to FIG. 8. FIG. 8 is a flow diagram illustrating an example of a procedure of selecting a vehicle body color on a vehicle body color selection screen displayed by the display control unit 404 according to a second modification of the embodiment.

As illustrated in (a) of FIG. 8, the user may select a color palette mode icon 62 or a list mode icon 63 on the vehicle body color selection screen. The operation receiving unit 407 receives such user selection. When the list mode icon 63 is selected, the operation unit 407 may receive such user selection, and the user may shift to the above-described list mode of selecting a vehicle icon having a predetermined vehicle body color from among vehicle icons having a plurality of different vehicle body colors.

When the user touches the color palette icon 62, the operation receiving unit 407 receives designation by such user operation, and as illustrated in (b) of FIG. 8, the display control unit 404 performs transition from the vehicle body color selection screen to a color palette display screen. When the user touches an arbitrary reference color and an arbitrary brightness from a color palette as a display mode setting group displayed on the color palette display screen, the operation receiving unit 407 may receive designation by such user operation and may select a vehicle body color having the arbitrary color and the arbitrary brightness. After confirming the selected vehicle body color from a vehicle icon on the left side of the color palette, the user touches the vehicle icon when the vehicle body color is acceptable. The operation receiving unit 407 receives designation by such user operation. Thus, the same animation display is performed as in (c) to (e) of FIG. 6, and as illustrated in (c) of FIG. 8, the selected vehicle body color may be reflected on the vehicle icon on the bird's-eye view image data.

According to the ECU 14 of the second modification of the embodiment, since an arbitrary reference color and an arbitrary brightness may be selected from the color palette, a color closer to the user's desired color may be obtained. Further, the selection of a vehicle body color depending on the brightness of the bird's-eye view image data display is further facilitated.

### Third Modification

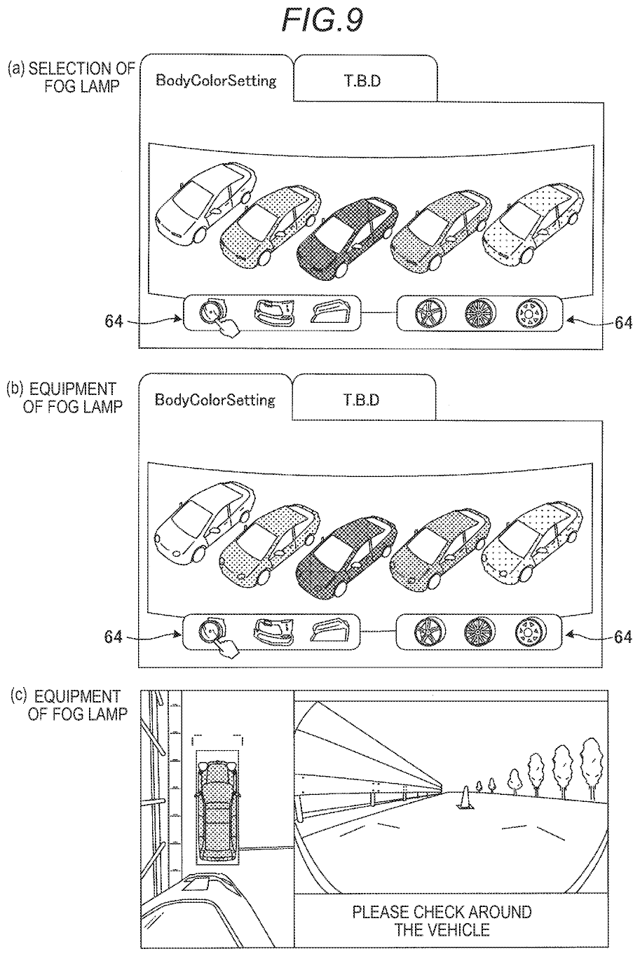

Control of the display control unit 404 according to a third modification of the embodiment will be described with reference to FIG. 9. FIG. 9 is a flow diagram illustrating an example of a procedure of selecting parts of a vehicle icon on a part selection screen displayed by the display control unit 404 according to a third modification of the embodiment. In the example of the third modification, it is possible to select parts to be equipped in the vehicle icon.

When the user selects a part selection icon (not illustrated) on the vehicle body color selection screen, the operation receiving unit 407 receives such user selection, and as illustrated in (a) of FIG. 9, the display control unit 404 performs transition from the vehicle body color selection screen to a part selection screen. In the part selection screen, the operation receiving unit 407 may receive selection by the user of an arbitrary part that the user wants to equip in a vehicle icon on the vehicle body color selection screen. In the example of FIG. 9, various part icons 64 such as a fog lamp, a front spoiler, a rear spoiler, and a plurality of types of tire aluminum wheels are illustrated in the lower region of the part selection screen.

By selecting a vehicle icon to be equipped with the selected part on the part selection screen, as illustrated in (b) of FIG. 9, arbitrary parts may be equipped in respective vehicle icons having different vehicle body colors on the vehicle body color selection screen. The example of (b) of FIG. 9 illustrates that the user selects a fog lamp and individual vehicle icons are equipped with the fog lamp.

By selecting any one vehicle icon equipped with an arbitrary part on the vehicle body color selection screen, the operation receiving unit 407 receives such user selection, and as illustrated in (c) of FIG. 9, the user may cause the vehicle icon of the bird's-eye view image data to be equipped with the selected part while reflecting the selected vehicle body color on the vehicle icon.

### Fourth Modification

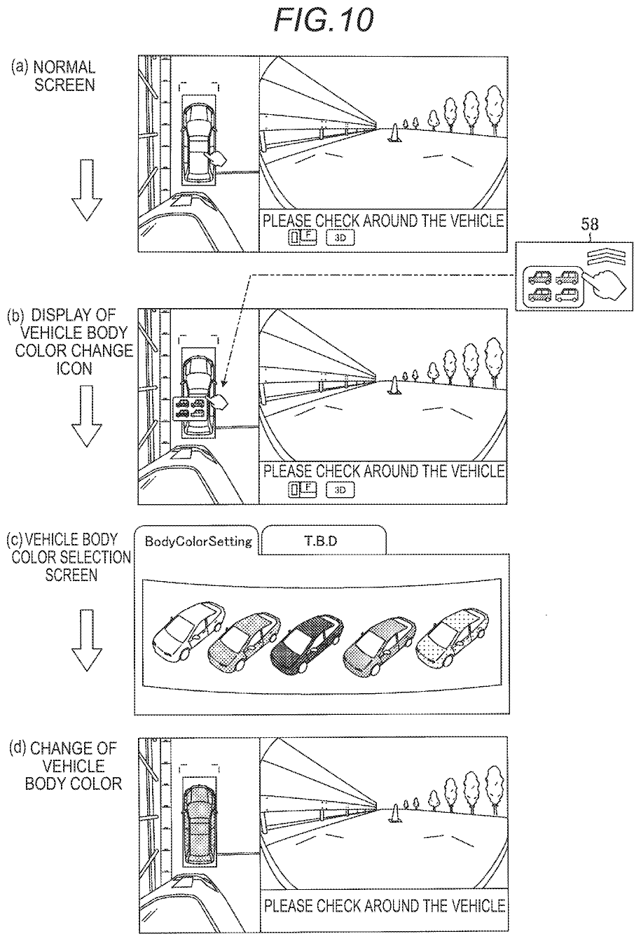

FIG. 10 is a flow diagram illustrating an example of a procedure of controlling a change of the vehicle body color of a vehicle icon by the display control unit 404 according to a fourth modification of the embodiment. The display control unit 404 of the fourth modification differs from the above-described embodiment in that it performs transition to the vehicle body color selection screen in a different procedure.

That is, as illustrated in (a) of FIG. 10, for example, when the user touches a vehicle icon in the bird's-eye view image data of the display device 8, the operation receiving unit 407 receives designation by such user operation, and as illustrated in (b) of FIG. 10, the display control unit 404 displays a vehicle body color change icon 58 as display information at a touch position of the display device 8.

The vehicle body color change icon 58 includes vehicle marks having different vehicle body colors, a mark in which two inverted “V” letters are superimposed, and a finger mark attached thereto. When the user moves the finger upward on the vehicle body color change icon 58, such an operation may be received by the operation receiving unit 407 and may cause the display control unit 404 to display the vehicle body color selection screen. The above-described user operation received by the operation receiving unit 407 may be sliding or dragging.

When the user performs, upward sliding or dragging according to the vehicle body color change icon 58, the operation receiving unit 407 receives designation by such user operation, and as illustrated in (c) of FIG. 10, the display control unit 404 performs transition of the display screen to the vehicle body color selection screen. When the user selects a predetermined vehicle body color on the vehicle body color selection screen, the operation receiving unit 407 receives such user selection, and as illustrated in (d) of FIG. 10, the display control unit 404 returns the display to the bird's eye view image data screen before transition so that the color which is arbitrarily designated by the user and is received by the operation receiving unit 407 is superimposed on the vehicle icon on the bird's-eye view image data screen as the vehicle body color of the vehicle icon.

As described above, the case of changing the color of the vehicle icon has mainly been described in the above-described embodiment and various modifications, but the disclosure is not limited thereto. The disclosure is not limited to the vehicle icon, and various display modes including a color and the like with respect to various types of vehicle information may be changed. For example, the presence or absence of flickering of the vehicle icon may be changed.

A display control device according to an aspect of this disclosure includes, as an example, an image acquisition unit configured to acquire captured image data from an imaging unit configured to capture an image of a peripheral area of a vehicle, a display control unit configured to cause composite image data generated based on the captured image data to be displayed on a composite image data screen, and an operation receiving unit configured to receive an operation from a user, wherein the display control unit causes the composite image data screen to transit to a setting screen on which a display mode of vehicle information on the composite image data screen is selectable when the operation receiving unit receives selection of display information displayed on the composite image data screen, and causes a selected display mode to be displayed on the composite image data screen as the display mode of the vehicle information when the operation receiving unit receives selection of the display mode on the setting screen.

Thus, as an example, it is possible to improve the controllability of the display of composite image data.

The display control unit may further cause a plurality of different display modes of vehicle information to be displayed on the setting screen, the operation receiving unit may further receive selection of one of the plurality of different display modes of the vehicle information, and the display control unit may further cause a display mode of the vehicle information on which selection has been received to be displayed on the composite image data screen as the display mode of the vehicle information.

Thus, as an example, the user may easily designate a desired vehicle body color.

The display control unit may further causes a display mode setting group with which the operation receiving unit is capable of receiving arbitrary designation by the user to be displayed on the setting screen, the operation receiving unit further receives designation of one display mode of the display mode setting group, and the display control unit may further cause a display mode of the vehicle information on which designation has been received to be displayed on the composite image data screen as the display mode of the vehicle information.

Thus, as an example, the user may further specifically designate a desired vehicle body color.

The display control unit may further causes a plurality of different parts to be displayed on the setting screen, the operation receiving unit may further receive selection of one of the plurality of different parts, and the display control unit may further causes a part on which selection has been received to be displayed on the composite image data screen, as a part of the vehicle information.

Thus, as an example, the user may designate a vehicle icon closer to a desired form.

The display control unit may cause an animation in which a size of the vehicle information on the setting screen gradually changes to be displayed and cause the setting screen to transit to the composite image data screen when the operation receiving unit receives the selection of the display mode on the setting screen.

Thus, as an example, since the size of the vehicle icon gradually changes by the animation display, it is obvious at a glance which body color is selected.

The display control unit may cause an animation in which a transmittance of the vehicle information on the setting screen gradually changes to be displayed and cause the setting screen to transit to the composite image data screen when the operation receiving unit receives the selection of the display mode on the setting screen.

Thus, as an example, since the transmittance of the vehicle icon gradually changes by the animation display, not only display consistency may be obtained, but also amusement is improved.

The display control unit may cause the setting screen to return to an original display state to cancel reception of user designation through the operation receiving unit when the operation receiving unit receives the designation of a predetermined position on the setting screen while the animation is displayed.

Thus, as an example, it is possible to redo the selection while displaying the animation.

When the operation reception unit receives designation of one of the plurality of different display modes of the vehicle information displayed on the setting screen, the display control unit may cause the designated display mode of the vehicle information to be displayed on the vehicle information on the composite image data screen in a superimposing manner.

Thus, as an example, the user may intuitively understand the operation procedure and may easily change the vehicle body color.

When the operation receiving unit receives dragging of one of the plurality of different display modes of the vehicle information displayed on the setting screen to a predetermined position on the setting screen, the display control unit may cause the dragged display mode of the vehicle information to be displayed on the vehicle information on the composite image data screen in a superimposing manner.

Thus, as an example, the user may intuitively understand the operation procedure and may easily change the vehicle body color.

The display control unit may cause the setting screen on which a mode for displaying a plurality of different display modes of vehicle information and a mode for displaying a display mode setting group with which the operation receiving unit is capable of receiving arbitrary designation by the user, are selectable to be displayed.

Thus, as an example, the user may select a method of changing the vehicle body color.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A display control device comprising:
an image acquisition unit configured to acquire captured image data from an imaging unit configured to capture an image of a peripheral area of a vehicle;
a display control unit configured to cause composite image data generated based on the captured image data to be displayed on a composite image data screen; and
an operation receiving unit configured to receive an operation from a user, wherein
the display control unit causes the composite image data screen to transit to a setting screen on which a display mode of vehicle information on the composite image data screen is selectable when the operation receiving unit receives selection of display information displayed on the composite image data screen, and causes a selected display mode to be displayed on the composite image data screen as the display mode of the vehicle information when the operation receiving unit receives selection of the display mode on the setting screen.

2. The display control device according to claim 1, wherein
the display control unit further causes a plurality of different display modes of vehicle information to be displayed on the setting screen,
the operation receiving unit further receives selection of one of the plurality of different display modes of the vehicle information, and
the display control unit further causes a display mode of the vehicle information on which selection has been received to be displayed on the composite image data screen as the display mode of the vehicle information.

3. The display control device according to claim 1, wherein
the display control unit further causes a display mode setting group with which the operation receiving unit is capable of receiving arbitrary designation by the user to be displayed on the setting screen,
the operation receiving unit further receives designation of one display mode of the display mode setting group, and
the display control unit further causes a display mode of the vehicle information on which designation has been received to be displayed on the composite image data screen as the display mode of the vehicle information.

4. The display control device according to claim 1, wherein
the display control unit further causes a plurality of different parts to be displayed on the setting screen,
the operation receiving unit further receives selection of one of the plurality of different parts, and
the display control unit further causes a part on which selection has been received to be displayed on the composite image data screen as a part of the vehicle information.

5. The display control device according to claim 1, wherein
the display control unit causes an animation in which a size of the vehicle information on the setting screen gradually changes to be displayed and causes the setting screen to transit to the composite image data screen when the operation receiving unit receives the selection of the display mode on the setting screen.

6. The display control device according to claim 1, wherein
the display control unit causes an animation in which a transmittance of the vehicle information on the setting screen gradually changes to be displayed and causes the setting screen to transit to the composite image data screen when the operation receiving unit receives the selection of the display mode on the setting screen.

7. The display control device according to claim 5, wherein
the display control unit causes the setting screen to return to an original display state to cancel reception of user designation through the operation receiving unit when the operation receiving unit receives the designation of a predetermined position on the setting screen while the animation is displayed.

8. The display control device according to claim 2, wherein
when the operation reception unit receives designation of one of the plurality of different display modes of the vehicle information displayed on the setting screen, the display control unit causes the designated display mode of the vehicle information to be displayed on the vehicle information on the composite image data screen in a superimposing manner.

9. The display control device according to claim 2, wherein
when the operation receiving unit receives dragging of one of the plurality of display modes of the vehicle information displayed on the setting screen to a predetermined position on the setting screen, the display control unit causes the dragged display mode of the vehicle information to be displayed on the vehicle information on the composite image data screen in a superimposing manner.

10. The display control device according to claim 1, wherein
the display control unit causes the setting screen on which a mode for displaying a plurality of different display modes of vehicle information and a mode for displaying a display mode setting group with which the operation receiving unit is capable of receiving arbitrary designation by the user are selectable to be displayed.
